(19) United States
(12) Patent Application Publication
(10) Pub. No.: US 2024/0155573 A1
(43) Pub. Date: May 9, 2024

(54) Time Domain Resource Selection

(71) Applicant: Apple Inc., Cupertino, CA (US)

(72) Inventors: Weidong Yang, San Diego, CA (US); Dawei Zhang, Saratoga, CA (US); Wei Zeng, San Diego, CA (US); Haitong Sun, Cupertino, CA (US); Hong He, Cupertino, CA (US); Sigen Ye, San Diego, CA (US); Ankit Bhamri, Bad Nauheim (DE); Oghenekome Oteri, San Diego, CA (US)

(21) Appl. No.: 18/496,029

(22) Filed: Oct. 27, 2023

Related U.S. Application Data
(60) Provisional application No. 63/422,663, filed on Nov. 4, 2022.

(51) Int. Cl. H04W 72/0446; H04W 72/20

(52) U.S. Cl. CPC H04W 72/0446; H04W 72/20

(57) ABSTRACT

This disclosure relates to techniques for selecting time domain resources in a wireless communication system. A wireless device and a cellular base station may establish a wireless link. The wireless device may receive an uplink grant that provides multiple uplink transmission occasions. The wireless device may select a subset of the multiple uplink transmission occasions and may perform uplink transmissions during the selected subset. The subset selected by the wireless device may be determined based on a resource adjustment rule for the wireless device. Each of the uplink transmissions may include an indication of uplink transmission occasions that are unused by the wireless device.

### PRIORITY INFORMATION

This application claims priority to U.S. provisional patent application Ser. No. 63/422,663, entitled “Time Domain Resource Selection,” filed Nov. 4, 2022, which is hereby incorporated by reference in its entirety as though fully and completely set forth herein.

### FIELD

The present application relates to wireless communications, and more particularly to systems, apparatuses, and methods for selecting time domain resources in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for selecting time domain resources in a wireless communication system.

According to the techniques described herein, a wireless device may be capable of using a resource adjustment rule to select a subset of time domain resources provided by an uplink grant when not all of the time domain resources provided by the uplink grant are needed by the wireless device to perform uplink transmissions. In some instances, it may be possible to use techniques described herein in conjunction with either or both of configured grant or dynamic grant uplink grant types. The wireless device may perform the uplink transmission(s) to a serving cellular base station using the selected subset of the time domain resources.

The cellular base station may perform transmission coordination between multiple such wireless devices, for example by providing uplink grants that include the same or at least partially overlapping resources to multiple wireless devices that are configured with different resource adjustment rules. For example, the resource adjustment rules with which the wireless devices are configured may be designed to minimize overlap between the time domain resources used by those wireless devices as much as possible. The resource adjustment rule(s) may be configured to be time-invariant or time-variant, according to various embodiments.

Additionally, or alternatively, it may be possible for a cellular base station to dynamically schedule a wireless device to make use of time domain resources that are vacated by another wireless device. This may be facilitated by a wireless device that is vacating some time domain resources providing signaling to the cellular base station to indicate the vacated resources, at least according to some embodiments.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for selecting time domain resources in a wireless communication system, according to some embodiments;

FIGS. 6-7 illustrate aspects of scenarios in which time domain resource adjustments for uplink transmissions could be performed, according to various embodiments; and

FIGS. 8-9 illustrate example aspects of possible sets of transmission occasion patterns that could be selected according to various resource adjustment rules in a possible transmission coordination scheme, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

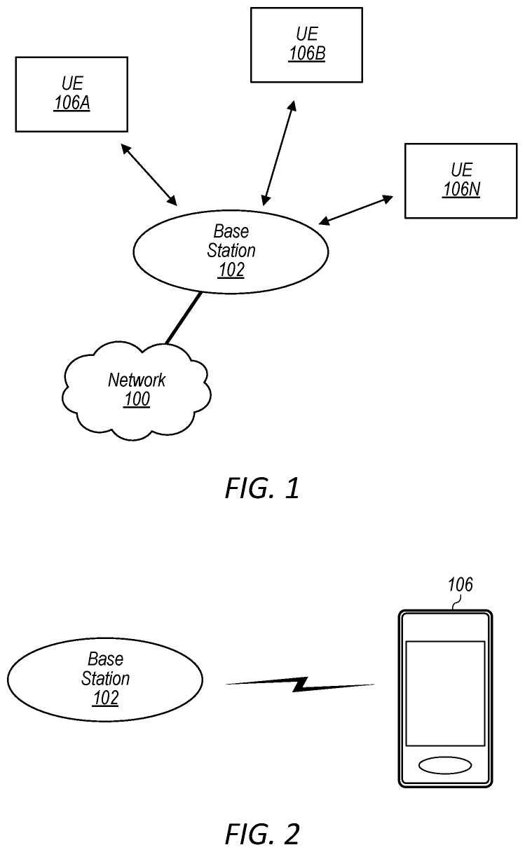

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

Note that, at least in some 3GPP NR contexts, base station (gNB) functionality can be split between a centralized unit (CU) and a distributed unit (DU). The illustrated base station 102 may support the functionality of either or both of a CU or a DU, in such a network deployment context, at least according to some embodiments. In some instances, the base station 102 may be configured to act as an integrated access and backhaul (IAB) donor (e.g., including IAB donor CU and/or IAB donor DU functionality). In some instances, the base station 102 may be configured to act as an IAB node (e.g., including IAB mobile termination (MT) and IAB-DU functionality). Other implementations are also possible.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for selecting time domain resources in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM, etc.), and separate radios for communicating using each of Wi-Fi and BLUETOOTH™. Other configurations are also possible.

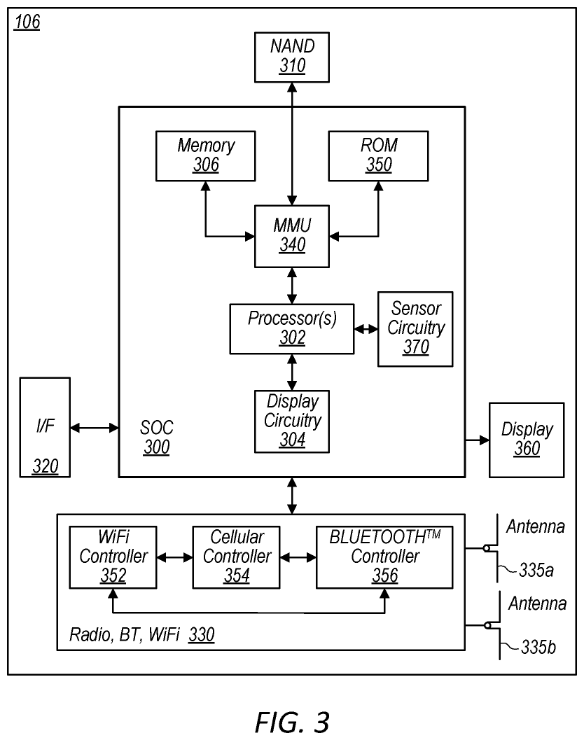

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector OF 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for selecting time domain resources in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for selecting time domain resources in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

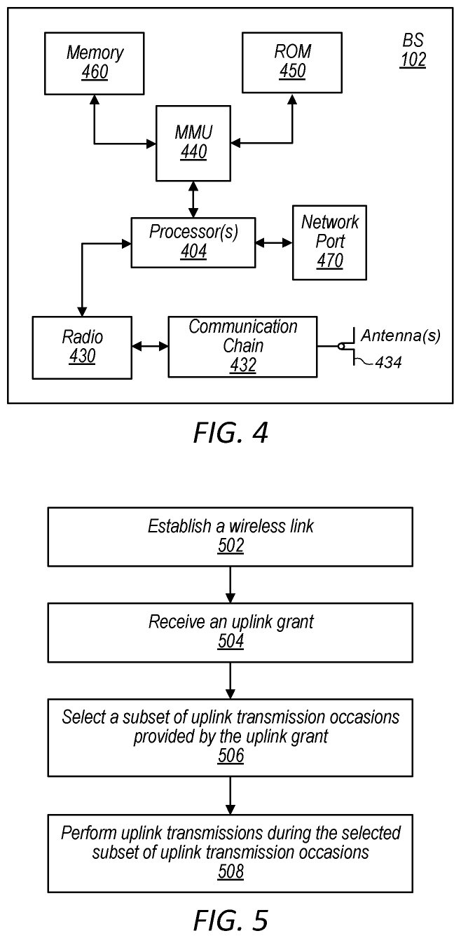

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNB s.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### FIG. 5—Time Domain Resource Selection

There may be cellular communication scenarios when a wireless device is over-provisioned with uplink transmission resources. Such scenarios could occur, for example, for low-latency traffic with variable frame sizes, for which it may be important to regularly provide uplink resources in sufficient quantity to handle larger frame sizes, but also for which only a portion of those uplink resources may be needed for smaller frame sizes. Such scenarios could also occur, for example, when a wireless device has a mixture of higher reliability traffic and lower reliability traffic, such that uplink resources may be provided in sufficient quantity to perform enough repetitions for the higher reliability traffic, although if none of the higher reliability traffic is present at the wireless device, the lower reliability traffic can be transmitted using fewer repetitions than could be supported with the amount of uplink resources provided to the wireless device.

Thus, at least in some scenarios, it may be beneficial to provide techniques for using a subset of the allocated resources for a transmission, e.g., to avoid unnecessary wireless device power consumption (e.g., by performing transmissions using more resources than needed) and/or inefficient network resource use. There may be a variety of possible ways of adjusting uplink transmission resource use, potentially including frequency domain resource adjustments and/or time domain resource adjustments. To illustrate one such set of possible techniques, FIG. 5 is a flowchart diagram illustrating a method for selecting time domain resources in a wireless communication system, at least according to some embodiments.

Aspects of the method of FIG. 5 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

In 502, the wireless device may establish a wireless link with a cellular base station. According to some embodiments, the wireless link may include a cellular link according to 5G NR. For example, the wireless device may establish a session with an AMF entity of the cellular network by way of one or more gNB s that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least in some instances, establishing the wireless link(s) may include the wireless device providing capability information for the wireless device. Such capability information may include information relating to any of a variety of types of wireless device capabilities.

In 504, the wireless device may receive an uplink grant for an uplink transmission on the wireless link. According to some embodiments, the uplink grant may include a configured grant (CG) or a dynamic grant (DG). In some instances, the uplink grant may provide multiple uplink transmission occasions (e.g., a set of time domain uplink transmission resources). For each of the uplink transmission occasions, certain time-frequency resources (e.g., including a set of frequency domain uplink transmission resources) may be provided by the uplink grant. The frequency resources may, for example, include a contiguous or non-contiguous allocation of physical resource blocks (PRBs).

In 506, the wireless device may select a subset of uplink transmission occasions provided by the uplink grant. Selecting the subset of uplink transmission occasions may be based at least in part on determining that fewer uplink transmission occasions than allocated by the uplink grant are needed at the current time, for example based at least in part on uplink data buffer size for the uplink data buffer of the wireless device (e.g., if the amount of data in the data buffer can be transmitted using fewer uplink transmission occasions than are allocated by the uplink grant), and/or based at least in part on reliability target information for uplink data stored in the uplink data buffer of the wireless device (e.g., if fewer uplink transmission occasions are needed to meet the reliability target than are allocated by the uplink grant).

In addition to selecting a number of uplink transmission occasions to use (and a corresponding number of uplink transmission occasions to vacate), selecting the subset of uplink transmission occasions may also include selecting which of the uplink transmission occasions allocated by the uplink grant to use (e.g., which pattern of uplink transmission occasions among multiple possible patterns of uplink transmission occasions). In some instances, the selection of which uplink transmission occasions to use may be based at least in part on a resource adjustment rule, which could be configured by the cellular base station (e.g., the wireless device could receive an explicit indication of the resource adjustment rule for the wireless device from the cellular base station), determined based on standard specification documents (e.g., the resource adjustment rule for the wireless device could be implicitly determined from multiple defined resource adjustment rules based on some wireless device characteristics or parameters or cellular network characteristics or parameters, among various possibilities), and/or determined based on wireless device implementation.

A variety of resource adjustment rules may be possible, and could include time-invariant and/or time-variant resource adjustment rules. As one example, one time-invariant resource adjustment rule could include always selecting as many uplink transmission occasions as needed starting from the earliest uplink transmission occasion allocated by the uplink grant. Another time-invariant resource adjustment rule could include selecting as many uplink transmission occasions as needed starting from the latest uplink transmission occasion allocated by the uplink grant. A time-variant resource adjustment rule could include determining whether to select as many uplink transmission occasions as needed starting from either the earliest or the latest uplink transmission occasion allocated by the uplink grant depending at least in part on a configured grant index for the uplink grant within the current radio frame. Numerous other resource adjustment rules (e.g., potentially including rules that result in patterns of non-contiguous uplink transmission occasions being selected, rules that are time-dependent based on other variables, etc.) are also possible. Note that, at least according to some embodiments, one possible benefit of using a time-variant resource adjustment rule could include potential randomization of interference effects on the selected subset of time domain resources for any given wireless device.

In 508, the wireless device may perform uplink transmissions during the selected subset of uplink transmission occasions. According to some embodiments, the wireless device may include an indication of unused uplink transmission occasions with each of the uplink transmissions performed by the wireless device that are associated with the uplink grant. Thus, in a 5G NR design, a wireless device may include an indication of unused uplink transmission occasions with each of the configured grant PUSCHs performed by the wireless device that are associated with an uplink configured grant configuration, at least as one possibility. Such an indication may be provided in any of a variety of possible formats. As one possibility, each of the uplink transmissions may include an indication of a number of remaining uplink transmission occasions in the selected subset of the uplink transmission occasions associated with the uplink grant (e.g., thereby indicating that any other uplink transmission occasions associated with the uplink grant are being vacated by the wireless device). As another possibility, each of the uplink transmissions may include an indication of a total number of uplink transmission occasions in the selected subset of the uplink transmission occasions, and/or an indication of a total number of uplink transmission occasions associated with the uplink grant that are being vacated by the wireless device. As a still further possibility, each of the uplink transmissions could include an indication of when the selected subset of the uplink transmission occasions associated with the uplink grant terminates (e.g., thereby indicating that any uplink transmission occasions subsequent to the indicated time are being vacated by the wireless device).

In some embodiments, it may additionally or alternatively be possible for the wireless device to provide an indication to the cellular base station of uplink resources for a subsequent uplink grant period (e.g., a subsequent configured grant period) for the wireless device that are being vacated by the wireless device. This may depend at least in part on the buffer status for the wireless device (e.g., if it is empty and/or the wireless device does not expect uplink traffic arrival during the next configured grant period) and/or other considerations, in various embodiments.

At least according to some embodiments, such an approach to performing time domain resource selection may be conducive to transmission coordination between multiple wireless devices, e.g., to potentially improve overall network resource use efficiency. For example, the cellular base station may establish a wireless link with another device, and may provide an uplink grant to that other wireless device, where the uplink grants for the wireless devices have at least some overlapping time and frequency resources. The different wireless devices may be configured with different (e.g., complementary) resource adjustment rules, such that if each of the wireless devices uses a subset of the allocated uplink transmission occasions according to their respective resource adjustment rules, it may be possible that there is no or minimal overlap between the resources actually used by the wireless devices. Thus, the cellular base station may be able to receive one or more uplink transmissions from one wireless device on one subset of the allocated uplink transmission occasions, and to receive one or more uplink transmissions from the other wireless device on a different subset of the allocated uplink transmission occasions, where the subsets of uplink transmission occasions for the different wireless devices are selected based on different resource adjustment rules.

As another (additional or alternative) possibility, it may be possible for a cellular base station to make use of such an approach to performing time domain resource selection to improve network resource use efficiency by providing a conditional or unconditional uplink grant to one or more wireless devices for uplink transmission occasions that are vacated by a wireless device.

For example, based on receiving an indication from the wireless device of one or more unused uplink transmission occasions associated with the uplink grant provided to the wireless device, the cellular base station could provide another uplink grant to another wireless device, where that second uplink grant includes the some or all of the uplink resources indicated to be unused/vacated by the first wireless device.

As another example, based on receiving an indication from the wireless device of one or more unused uplink transmission occasions associated with a subsequent uplink grant period, the cellular base station could provide another uplink grant to another wireless device, where that second uplink grant includes the some or all of the uplink resources indicated to be unused/vacated by the first wireless device for the subsequent uplink grant period.

As a still further example, it may be possible for the cellular base station to provide a conditional uplink grant to a second wireless device, where the conditional uplink grant overlaps at least partially with the uplink grant provided to the first wireless device. In such a scenario, the second wireless device may not use the conditional uplink grant unless a further (e.g., low overhead/latency) signal is provided to the second wireless device by the cellular base station. Thus, based on receiving the indication of the unused uplink transmission occasions from the first wireless device, the cellular base station may provide a such a signal to the second wireless device, e.g., to indicate that the conditional uplink transmission occasion(s) are available to the second wireless device.

Thus, at least according to some embodiments, the method of FIG. 5 may be used to provide a framework according to which a wireless device can perform uplink transmissions using a subset (or the full set) of the possible time domain resources, and thus to potentially reduce wireless device power consumption and/or to assist a cellular network to more effectively and efficiently use network resources in a variety of possible scenarios, at least in some instances. Note that since a subset or the full set can be used, it may be possible that all of the various possible patterns of contiguous and non-contiguous uplink transmissions(s) may be selectable by a wireless device.

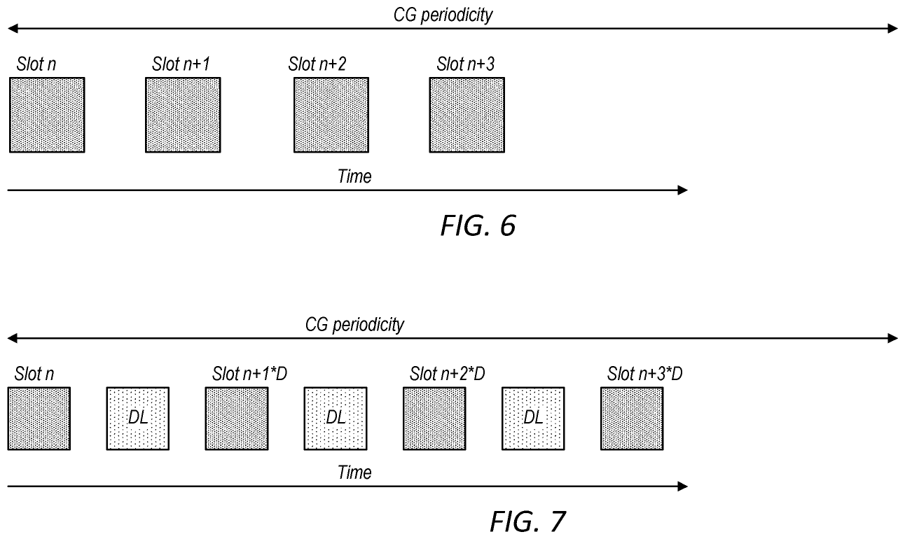

### FIGS. 6-9 and Additional Information

FIGS. 6-9 illustrate further aspects that might be used in conjunction with the method of FIG. 5 if desired. It should be noted, however, that the exemplary details illustrated in and described with respect to FIGS. 6-9 are not intended to be limiting to the disclosure as a whole: numerous variations and alternatives to the details provided herein below are possible and should be considered within the scope of the disclosure.

In at least some cellular communication techniques, uplink transmissions can be scheduled using dynamic grants or configured grants. In some scenarios it may be possible that a configured grant provides more resources than needed for the uplink traffic at a wireless device. For example, for extended reality (XR) traffic, the video frame size can vary with time, at least in some instances. If a configured grant (CG) is used to carry the XR traffic, e.g., for a video stream, time-frequency resources may be over-provisioned (e.g., to support the larger end of the range of possible video frame sizes, which may result in more resources being available than needed when the XR traffic is at the smaller end of the range of possible video frame sizes) in order to avoid prolonged transmissions, which may not be conducive to low-latency targets for transmission in the XR use case. As another example, for XR traffic, due to large quantization steps in the buffer status report (BSR) reporting, the gNB may not know precisely the buffer status of a UE. It could accordingly occur that a configured grant configuration for such a UE is configured for a traffic stream with a high reliability target when the current media access control (MAC) protocol data unit (PDU) doesn't contain any traffic from a high reliability traffic stream, in which case the UE may be able to use a lower reliability target for the configured grant, which may utilize fewer of the configured grant resources.

In view of the possibility of such over-provisioning of uplink resources, whether for configured grant or dynamic grant scenarios, and whether for XR use cases and/or other use cases, it may be useful to provide techniques for a UE to select which subset of the provisioned uplink resources to use to perform an uplink transmission, and/or to provide techniques for dynamically signaling the presence of unused uplink resources (e.g., CG physical uplink shared channel (PUSCH) occasion(s) or resource(s)) by a UE to a cellular network, e.g., to facilitate re-use of those unused resources for improved network resource use efficiency.

Multiple configured grant designs may be possible according to various cellular communication techniques and/or standards versions. According to some embodiments, some or all of single-slot PUSCH design, an ultra reliable low latency communication (URLLC) design, and/or a NR-U design may be used.

A single-slot PUSCH design could include a configured grant design in which the configured grant provides a single slot PUSCH transmission opportunity. This design may be supported from 3GPP Release 15, according to some embodiments. At least in some embodiments, given the same code rate and resource allocation (e.g., 20 physical resource blocks (PRBs) over 14 symbols), using a single PUSCH allocation (e.g., including 5 PRBs over 14 symbols) can be advantageous in harvesting coding gain compared with the case with two PUSCHs (e.g., with the first PUSCH including 5 PRBs over symbols 0-6 and the second PUSCH including 5 PRBs over symbols 7-13).

In a URLLC design (e.g., supported from 3GPP Release 16, according to some embodiments) multiple CG configurations with Type 1 (e.g., RRC configured) and Type 2 (e.g., DCI configured) may be supported on the same cell, and PUSCH repetition Type A and PUSCH repetition Type B may be supported for configured grants; note that for transmissions over slots/actual transmissions, the same transport block may be carried. In some embodiments, resource adjustment for such a design can be motivated to improve support for data with different reliability requirements. For example, for a scenario in which a first data stream and a second data stream are carried over the same CG configuration, but the first data stream has more stringent reliability requirements than the second data stream, the UE may be able to adjust the number of repetitions needed for a given uplink transmission depending on whether packets from the first data stream are sent or packets from the second data stream are sent.

In a NR-U design (e.g., supported from 3GPP Release 16, according to some embodiments), multiple occasions of PUSCH with different transport blocks may be supported. In some embodiments, resource adjustment for such a design can be motivated to improve support for scenarios in which packet size in a data stream varies over time (e.g., in which video frame size can vary from time to time), at least according to some embodiments.

According to some embodiments, it may be possible for resource use adjustments to be performed in the time domain. FIGS. 6-7 illustrate aspects of scenarios in which such time domain adjustments could be performed, according to various embodiments.

FIG. 6 illustrates aspects of one possible scenario in which a CG PUSCH is associated with multiple transmission occasions (e.g., in a URLLC design or NR-U design scenario). In the illustrated example, a PUSCH is associated with transmissions in slot n, slot n+1, slot n+2, and slot n+3. Depending on the uplink traffic arrival at a UE and the resulting data buffer size and/or reliability target at the UE, the UE may be able to use a single occasion (e.g., slot n) or two occasions (e.g., slot n, slot n+1), while vacating the remaining resources (e.g., slots n+1 through n+3 may be vacated if only slot n is used, slots n+2 through n+3 may be vacated if slot n and slot n+1 are used, etc.). The vacated resources may not generate interference to other uplink transmissions, and the gNB may be able to schedule UEs in the vacated uplink transmission resources. However, it should be noted that the gNB may need a certain amount of time to process an indication received in slot n, e.g., such that an instantaneous reaction leading to a scheduling decision and corresponding signaling may not be possible in sufficient time to effectively use the vacated resources in response to an indication at slot n, at least in some instances, e.g., in particular if the configured grant includes consecutive slots. Note also that for a typical time division duplexing (TDD) split, it may be relatively unlikely that consecutive uplink slots are configured, at least according to some embodiments.

FIG. 7 illustrates aspects of another possible scenario in which a CG PUSCH is associated with multiple transmission occasions (e.g., in a URLLC design or NR-U design scenario). In the illustrated example, a PUSCH is associated with transmissions in slot n, slot n+1*D, slot n+2*D, and slot n+3*D. In other words, the “step” between neighboring occasions for the configured grant may be D (e.g., instead of 1), such that the occasions may be non-consecutive. Depending on the uplink traffic arrival at a UE and the resulting data buffer size and/or reliability target at the UE, the UE may be able to use a single occasion (e.g., slot n) or two occasions (e.g., slot n, slot n+1*D), while vacating the remaining resources (e.g., slots n+1*D through n+3*D may be vacated if only slot n is used, slots n+2*D through n+3*D may be vacated if slot n and slot n+1*D are used, etc.). The vacated resources may not generate interference to other uplink transmissions, and the gNB may be able to schedule UEs in the vacated uplink transmission resources. Such a setup may work with a typical TDD DL/UL split, and may provide more time for a gNB schedule to react to an indication received in slot n. However, since there may be DL slot(s) inserted between the uplink slots in the scenario of FIG. 7, in some instances it may be possible that one or more dynamic grants are used to schedule the uplink transmission(s) instead of a configured grant for such a scenario. Such a spread (in the time domain) of uplink slots may serve the low latency requirements for some XR uplink traffic well. In some embodiments, the indication may be for eligible uplink transmission occasions only.

In some embodiments, it may be useful for a UE that vacates some time-domain resources provided by an uplink grant to provide an indication of the unused uplink resources, e.g., to facilitate their scheduling and use by another UE for improved network resource usage efficiency. As one such possibility, it may be possible for a UE to provide one indication of a time-domain resource adjustment, e.g., in the first uplink transmission occasion for a configured grant. Such an approach may, for example, target a scenario in which uplink slots for CG transmissions are spread out (e.g., such as in the scenario of FIG. 7), so that the gNB may have enough time to reschedule other UEs on the vacated resources. However, at least in some scenarios, it may be possible that the “first CG PUSCH” occasion could be ambiguous; for example, in CG design, with Type A PUSCH repetition with a redundance version sequence [0303], it may be the case that the UE is allowed to start a CG transmission at the first configured slot or the 3^{rd} configured slot (a slot associated with redundance version “0”), hence where the indication of used CG PUSCHs is to be included may not be clear. As another example, in CG design, with Type B PUSCH repetition, due to possible collision with downlink symbols, it may be the case that a nominal repetition can be dropped or segmented into actual repetitions, hence it could occur that where the indication of used CG PUSCHs is to be included may not be clear. Further, in NR-U CG design, depending on channel access outcome, it could be the case that a UE may start a transmission from the second slot, or the third slot, etc. Thus, the detection of the indication may not be robust in all circumstances if its transmission is performed only on the first CG PUSCH occasion.

In some embodiments, it may be possible, if “D” is sufficiently large, for a configured grant to be used in slot n, and the CG in slot n may carry buffer status report (BSR) information. From the BSR, the gNB may be able to obtain information on the buffer status of the UE. Accordingly, the gNB may be able to perform dynamic grant scheduling for the UE (as needed) in any or all of slot n+D, slot n+2*D, and slot n+3*D, in which case resource adjustment for the CG may not be needed.

In some instances, it may be possible that BSR quantization is relatively coarse. As a result, it may be possible that a gNB and a UE are not closely synchronized on the data buffer size of the UE, which could result in overallocation in dynamic grant PUSCH allocations as well. It may be possible, at least according to some embodiments, that a single DCI scheduling multiple PUSCHs can be used (e.g., for XR and/or for other possible use cases, according to various embodiments).

In case of a small “D” value or otherwise as desired, for CG and/or DG scenarios in which multiple uplink transmission opportunities are provided by the uplink grant, another possible approach may include providing an indication of unused PUSCH resources (e.g., vacated uplink time-domain resources) that can be carried in every CG and/or DG transmission.

The indication of the unused resources can be carried, for example, in CG-UCI signaling or a similar signaling design to leverage an existing processing procedure for CG-UCI such as UCI-multiplexing. There may be multiple possible approaches to how the presence of unused resources can be indicated. As one possibility, the signaling may be indicative for a number of PUSCH transmissions to follow the current PUSCH transmission. Thus, the signaling content for “unused resources” could change for each PUSCH transmission; for example, for a scenario with 4 PUSCH occasions for the number of PUSCH transmissions following the current PUSCH transmission, where the first and second occasions are actually used, then the “unused resources” signaling in the first PUSCH may indicate that 1 PUSCH transmission following the current PUSCH transmission is used, and the “unused resources” signaling in the second PUSCH may indicate that 0 PUSCH transmissions following the current PUSCH transmission is used.

As another possibility, the signaling may be indicative of the total number of PUSCH transmissions actually used by the UE. Thus, the signaling content for “unused resources” could remain the same for each PUSCH transmission; for example, for a scenario with 4 PUSCH occasions, where the first and second occasions are actually used, then the “unused resources” signaling in the first PUSCH may indicate that 2 PUSCH transmissions are used, and the “unused resources” signaling in the second PUSCH may also indicate that 2 PUSCH transmissions are used. Note that an approach in which the signaling content does not change in the PUSCH transmissions may be more beneficial for facilitating combining PUSCH repetitions, at least according to some embodiments.

In some designs, as described further herein, it may be possible that when time domain resource adjustment is performed, the selected CG PUSCH transmission(s) from some UEs may be configured to start from the first occasions within a window, while other UEs may be configured to start from the last occasions within a window. With the previously described techniques for signaling unused resources, in a scenario in which a CG PUSCH transmission can start from the middle of a set of CG PUSCH transmission opportunities, it could still be possible for when the transmissions terminate to be ambiguous. Accordingly, as another possible approach, it could be possible that the signaling content for “unused resources” could indicate the termination time of all transmissions in the CG PUSCH transmission opportunities provided by the uplink grant. This may facilitate unequivocal determination of the termination time for the resources used by a UE, at least according to some embodiments.

In some cases, when a UE is sure there is no traffic arrival during the next CG period or its data buffer is empty, the UE may be able to indicate potential unused resources for the next CG period (e.g., assuming it is not too early for the UE to determine whether and which CG resources it might use in the next CG period), which may give the gNB enough time to schedule other UEs on the vacated resources. Thus the “unused resources” indication can be applied to uplink transmission occasions across CG period boundaries, at least in some embodiments.

Depending on traffic type, it may be possible for a gNB to opportunistically schedule another UE or set of UEs, e.g., conditionally, at the same or an overlapping set of times as a CG. In such a scenario, if the gNB receives an indication from the UE scheduled with the CG that there is no data for a portion of the resources of the CG, the gNB may be able to send a low overhead signal to a UE that was conditionally scheduled to transmit in the remainder of the resources. The other UEs could, for example, be enhanced mobile broadband (eMBB) or industrial internet of things (IIoT) devices (e.g., sensors with data), among various possibilities.

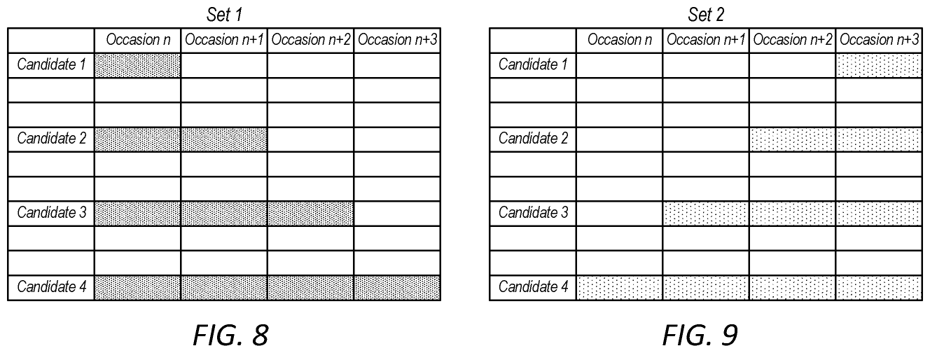

When the time interval between two adjacent CG occasions is relatively small, as previously noted, it may be the case that the gNB does not have enough time to schedule other UEs on the vacated resources in response to an indication that those resources have been vacated. In such a scenario, and/or in various other possible scenarios, it may be possible to implement a time domain transmission coordination scheme. FIGS. 8-9 illustrate aspects of an example of such a possible transmission coordination scheme, according to some embodiments. In the illustrated example, 4 occasions may be configured for two UEs (e.g., the UEs may be in UL MU-MIMO pairing at the same cell, or the two UEs may be from adjacent cells, in various embodiments). Depending on the buffer status for the first UE, the first UE may use set 1 (illustrated in FIG. 8) to decide on which occasions to perform uplink transmissions. Similarly, depending on the buffer status for the second UE, the second UE may use set 2 (illustrated in FIG. 9) to decide on which occasions to perform uplink transmissions. Thus, in many scenarios, the transmissions of UE 1 and UE 2 may not interfere with each other at all. Note that other patterns in addition or alternatively to the example resource adjustment patterns illustrated in FIGS. 8-9 are also possible; for example, non-contiguous patterns (e.g., [1 0 1 0] as candidate 2 for set 1 instead of [1 1 0 0] and [0 1 0 1] as candidate 2 for set 2 instead of [0 0 1 1], as one option) are also possible. In some instances, the pattern, which may contain non-contiguous “1”s, can be indicated by a combinatorial index, e.g., to indicate the selected k positions out of N possible positions. For example, such an index could be configured such that 1≤K₁≤k≤K₂≤N, where K₁ is the smallest number of occasions the UE can take, K₂ is the largest number of occasions the UE can take, and N is the total number of occasions available in a grant.

According to some embodiments, it may be possible that a UE is configured to always use the same set/resource selection rule to determine on which occasions to perform uplink transmissions depending on the buffer status of the UE. However, in some embodiments, it may be preferable to configure time-varying set selection, e.g., to randomize interference among UEs in the system. For example, as one possibility, the index of CG occurrences within a radio frame can be used to choose one set out of multiple sets. RRC configuration of the initial set selection Iᵢₙᵢₜ and set selection periodicity can be used:

I(t)=mod(Iᵢₙᵢₜ+I,P)

It may also be possible to signal the used and unused CG occurrences or used and unused uplink transmission occasions, e.g., as opposed to using an index.

In the following further exemplary embodiments are provided.

One set of embodiments may include a method, comprising: by a wireless device: establishing a wireless link with a cellular base station; receiving an uplink grant, wherein the uplink grant provides multiple uplink transmission occasions; selecting a subset of the multiple uplink transmission occasions; and performing uplink transmissions during the selected subset of the multiple uplink transmission occasions, wherein each of the uplink transmissions includes an indication of unused uplink transmission occasions.

According to some embodiments, each of the uplink transmissions includes an indication of a number of remaining uplink transmission occasions in the selected subset of the multiple uplink transmission occasions.

According to some embodiments, each of the uplink transmissions includes an indication of a number of uplink transmission occasions in the selected subset of the multiple uplink transmission occasions.

According to some embodiments, each of the uplink transmissions includes an indication of a total number of uplink transmission occasions in the selected subset of the multiple uplink transmission occasions.

According to some embodiments, each of the uplink transmissions includes an indication of when the selected subset of the multiple uplink transmission occasions terminates.

According to some embodiments, the method further comprises: providing an indication to the cellular base station of uplink resources for a subsequent configured grant period for the wireless device that are vacated by the wireless device.

According to some embodiments, selecting the subset of the multiple uplink transmission occasions is based at least in part on one or more of: uplink data buffer size for an uplink data buffer of the wireless device; or reliability target information for uplink data stored in the uplink data buffer of the wireless device.

According to some embodiments, selection of the subset of the multiple uplink transmission occasions is performed based at least in part on a time-invariant resource adjustment rule.

According to some embodiments, selection of the subset of the multiple uplink transmission occasions is performed based at least in part on a time-variant resource adjustment rule.

According to some embodiments, the uplink grant includes a configured grant (CG), wherein the time-variant resource adjustment rule is based at least in part on a CG index within a current radio frame.

Another set of embodiments may include a wireless device, comprising: an antenna; a radio operably coupled to the antenna; and a processor operably coupled to the radio; wherein the wireless device is configured to: establish a wireless link with a cellular base station; receive an uplink grant, wherein the uplink grant provides multiple uplink transmission occasions; select a subset of the multiple uplink transmission occasions, wherein the subset of the multiple uplink transmission occasions is selected based at least in part on a resource adjustment rule; and perform uplink transmissions during the selected subset of the multiple uplink transmission occasions.

According to some embodiments, the subset of the multiple uplink transmission occasions is selected based at least in part on one or more of: uplink data buffer size for an uplink data buffer of the wireless device; or reliability target information for uplink data stored in the uplink data buffer of the wireless device.

According to some embodiments, the wireless device is further configured to: receive an indication of the resource adjustment rule from the cellular base station.

According to some embodiments, the resource adjustment rule is used to determine an uplink transmission occasion pattern for the selected subset of the multiple uplink transmission occasions from multiple possible uplink transmission occasion patterns.

According to some embodiments, each of the uplink transmissions includes an indication of unused uplink transmission occasions.

Yet another set of embodiments may include an apparatus, comprising: a processor configured to cause a cellular base station to: establish a first wireless link with a first wireless device; provide a first uplink grant to the first wireless device, wherein the first uplink grant provides a first set of uplink transmission occasions to the first wireless device; and receive uplink transmissions from the first wireless device during a subset of the first set of uplink transmission occasions, wherein each of the uplink transmissions received from the first wireless device includes an indication of unused uplink transmission occasions associated with the first uplink grant.

According to some embodiments, each of the uplink transmissions received from the first wireless device during the subset of the first set of uplink transmission occasions includes an indication of one or more of: a number of remaining uplink transmission occasions associated with the first uplink grant that are used by the wireless device; a total number of uplink transmission occasions associated with the first uplink grant that are used by the wireless device; or an indication of when uplink transmission occasions associated with the first uplink grant that are used by the wireless device terminate; or the contiguous or non-contiguous uplink transmission pattern itself.

According to some embodiments, the processor is further configured to cause the cellular base station to: receive an indication from the first wireless device of uplink resources for a subsequent configured grant period for the first wireless device that are vacated by the first wireless device; and provide a second uplink grant to a second wireless device, wherein the second uplink grant includes the uplink resources for the subsequent configured grant period for the first wireless device that are vacated by the first wireless device.

According to some embodiments, the processor is further configured to cause the cellular base station to: establish a second wireless link with a second wireless device; provide a second uplink grant to the second wireless device, wherein the second uplink grant provides one or more conditional uplink transmission occasions to the second wireless device, wherein the one or more conditional uplink transmission occasions overlap with one or more uplink transmission occasions in the first set of uplink transmission occasions; and provide a signal to the second wireless device to indicate that the one or more conditional uplink transmission occasions are available based at least in part on the indication of unused uplink transmission occasions from the first wireless device.

According to some embodiments, the processor is further configured to cause the cellular base station to: provide an indication of a resource adjustment rule to the first wireless device, wherein the subset of the first set of uplink transmission occasions is selected by the first wireless device based at least in part on the resource adjustment rule.

According to some embodiments, the processor is further configured to cause the cellular base station to: establish a second wireless link with a second wireless device; provide a second uplink grant to the second wireless device, wherein the second uplink grant provides a second set of uplink transmission occasions to the second wireless device, wherein the first set of uplink transmission occasions overlap at least partially with the second set of uplink transmission occasions; and receive uplink transmissions from the second wireless device during a subset of the second set of uplink transmission occasions, wherein the subset of the first set of uplink transmission occasions and the subset of the second set of uplink transmission occasions are selected based on different resource adjustment rules.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
receiving an uplink grant that indicates multiple uplink transmission occasions; and
performing, on a plurality of the multiple uplink transmission occasions, uplink transmissions that each include a respective indication of unused status for one or more of the multiple uplink transmission occasions.

2. The method of claim 1,
wherein each respective uplink transmission of the plurality of uplink transmissions includes the respective indication of unused status for a number of uplink transmission occasions following the respective uplink transmission.

3. The method of claim 2,
wherein every uplink transmission on the multiple uplink transmission occasions includes the respective indication of unused status for one or more of the multiple uplink transmission occasions.

4. The method of claim 3,
wherein the plurality of uplink transmissions comprise physical uplink shared channel (PUSCH) transmissions, wherein the respective indications are comprised in uplink control information (UCI) multiplexed in the PUSCH transmissions.

5. The method of claim 1,
wherein the uplink grant includes one of:
a radio resource control (RRC) configured Type 1 configured grant (CG) physical uplink shared channel (PUSCH) transmission; or
a downlink control information (DCI) associated type 2 CG PUSCH transmission.

6. The method of claim 1,
wherein the uplink grant includes a configured grant (CG) physical uplink shared channel (PUSCH) transmission with type B repetition.

7. The method of claim 1,
wherein the uplink grant includes a dynamic grant (DG) physical uplink shared channel (PUSCH) transmission.

8. The method of claim 1, further comprising:
selecting a subset of the multiple uplink transmission occasions for the one or more uplink transmissions.

9. The method of claim 8, further comprising:
selecting the subset of the multiple uplink transmission occasions for the one or more uplink transmissions based at least in part on one or more of:
uplink data buffer size for an uplink data buffer of the wireless device; or
reliability target information for uplink data stored in the uplink data buffer of the wireless device.

10. The method of claim 1, further comprising:
providing an indication to a cellular base station of uplink resources for a subsequent configured grant period for the wireless device that are vacated by the wireless device.

11. A wireless device, comprising:
radio circuitry; and
a processor operably coupled to the radio circuitry;
wherein the wireless device is configured to:
receive an uplink grant that provides multiple uplink transmission occasions; and
perform, on a plurality of the multiple uplink transmission occasions, uplink transmissions that each include a respective indication of unused status for one or more of the multiple uplink transmission occasions.

12. The wireless device of claim 11,
wherein each respective uplink transmission of the plurality of uplink transmissions includes the respective indication of unused status for a number of uplink transmission occasions following the respective uplink transmission.

13. The wireless device of claim 12,
wherein every uplink transmission on the multiple uplink transmission occasions includes the respective indication of unused status for one or more of the multiple uplink transmission occasions.

14. The wireless device of claim 13,
wherein the plurality of uplink transmissions comprise physical uplink shared channel (PUSCH) transmissions, wherein the respective indications are comprised in uplink control information (UCI) multiplexed in the PUSCH transmissions.

15. The wireless device of claim 11, wherein the uplink grant includes at least one of:
a radio resource control (RRC) configured Type 1 configured grant (CG) physical uplink shared channel (PUSCH) transmission;
a downlink control information (DCI) associated type 2 CG PUSCH transmission;
a CG PUSCH transmission with type B repetition; or
a dynamic grant (DG) PUSCH transmission.

16. A non-transitory memory element storing instructions executable by a processor to:
provide, to a first wireless device, a first uplink grant that provides a first set of uplink transmission occasions to the first wireless device; and
receive, from the first wireless device during the first set of uplink transmission occasions, uplink transmissions that each include a respective indication of unused status for one or more of the uplink transmission occasions associated with the first uplink grant.

17. The non-transitory memory element of claim 16,
wherein each respective uplink transmission received on the first set of uplink transmission occasions includes the respective indication of unused status for a number of uplink transmission occasions following the respective uplink transmission.

18. The non-transitory memory element of claim 17,
wherein every uplink transmission on the first set of uplink transmission occasions includes the respective indication of unused status for one or more of the multiple uplink transmission occasions.

19. The non-transitory memory element of claim 18,
wherein the uplink transmissions received on the first set of uplink transmission occasions comprise physical uplink shared channel (PUSCH) transmissions, wherein the respective indications are comprised in uplink control information (UCI) multiplexed in the PUSCH transmissions.

20. The non-transitory memory element of claim 16, wherein the uplink grant includes at least one of:
a radio resource control (RRC) configured Type 1 configured grant (CG) physical uplink shared channel (PUSCH) transmission;
a downlink control information (DCI) associated type 2 CG PUSCH transmission; or
a CG PUSCH transmission with type B repetition.
